(19) United States
(12) Patent Application Publication
(10) Pub. No.: US 2006/0101059 A1
(43) Pub. Date: May 11, 2006

(54) Employment method, an employment management system and an employment program for business system

(76) Inventors: Yuji Mizote, Kamakura (JP); Tetsuya Hashimoto, Kawasaki (JP); Kenta Takahashi, Yokohama (JP); Naoki Ikawa, Yokohama (JP); Takaichi Ishida, Yokohama (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/070,886

(22) Filed: Mar. 3, 2005

(30) Foreign Application Priority Data
Oct. 27, 2004 (JP) 2004-311959

(51) Int. Cl. G06F 7/00

(52) U.S. Cl. 707/102

(57) ABSTRACT

A business system on the Web base having a plurality of system apparatuses and software components aims at reducing a load on configuration works and employment works of the business system. In an employment management system for the business system having a plurality of system apparatuses, a storage device stores unit configuration information, a plurality of methods constituting a common interface, and a program for each method. The common interface has at least a partial halt method for making the unit halt an operation of the business system and a partial restart method for making the unit restart the operation of the business system. When an arithmetic processing part performs employment operations by making a predetermined system apparatus halt the operation of the business system, the unit including the predetermined system is subjected to partial halt, employment operations and then partial restart.

### INCORPORATION BY REFERENCE

The present application claims priority from Japanese application JP2004-311959 filed on Oct. 27, 2004, the content of which is hereby incorporated by reference into this application.

### BACKGROUND OF THE INVENTION

The present invention relates to an employment method, an employment management system and an employment program, for a scalable business system running non-stop for 24 hours combining a plurality of apparatuses and software components.

A recent business system on the Web base is becoming highly sophisticated and complicated, and there exists a great amount of load on system designs, capacity planning, configuration and employment. Requirements for 24-hour service provision such as on-line services are becoming higher, and there are large needs for 24-hour non-stop maintenance.

A business system on the Web base is constituted of a number of system apparatuses, networks and software components, and there are a variety of topologies and configurations. It is therefore necessary to supply a special order for each case of system configuration designs, system employment designs, system configuration developments and system automatic employment program developments.

For example, the Publication of JP-A-2003-507817 (paragraphs [0017] to [0019], FIG. 2) (Patent Document 1) discloses the technology of realizing automation of initial configuration works and apparatus configuration changes (addition, deletion and the like of processors), among configuration employment works of a business system (described as a virtual server farm in Patent Document 1) constituted of processors, storage devices and network facilities. Automation of these works includes: settings of a VLAN (Virtual Local Area Network) and a SAN (Storage Area Network); relations between processors and operating system (OS, including middleware) boot images; and relations between processors and load balancers. However, the automation does not include settings of middleware running on processors, such as settings of a J2EE (Java (registered trademark) 2 Enterprise Edition: R) server and an HTTP (Hyper Text Transfer Protocol) server, and deployment of applications, in accordance with the topology of the system. Further, for the employment of 24-hour non-stop business services, it is necessary to perform employment designs for each case on a virtual server farm like a conventional manner, and to develop employment programs by supplying a special order.

From the viewpoint of tier-traverse employment management, the specification of U.S. Patent Application Publication No. 2003/0005426A1 (Patent Document 2) discloses a non-stop software version-up for a business system configured by a multitier architecture. The tier has a meaning of a physical layer or a logical layer, and the same meaning is indented hereinafter for the simply described term “layer”. However, Patent Document 2 describes neither a method of solving an issue of variety of configurations of a Web-based business system, nor a countermeasure for non-stop 24 hours employment operations other than the software version-up.

As described above, the issues associated with Patent Documents 1 and 2 reside in that the framework of designs and developments of employment programs in a variety of employment scenarios is not still provided for a Web-based business system having a variety of system configurations.

For the issues regarding this framework, “Management of Application Complexes in Multi-tier Clustered Systems”, by Ofer Biran et al, IBM System Journal, 2003, Vol. 42, No. 1 discloses the following technique. An employment operation logic portion which is different at each of a variety of system configurations is separated from a framework portion capable of being processed universally, and the employment operation logic portion different at each configuration is implemented as a plugin program for each of a variety of system configurations. The plugin program supports a common interface called Configuration Provider Interface. By using this framework, common GUI (Graphical User Interface) portions of employment operations can be used. However, most processes excluding GUI are required to be specifically developed for each of a variety of configurations, and common processes by the framework are still insufficient.

### SUMMARY OF THE INVENTION

It is therefore an object of the present invention to reduce a load of configuration and employment works of a Web-based business system constituted of a plurality of system apparatuses and software components, and reduce a load of developments of employment designs and programs for the employment of a 24 hours non-stop business system.

In order to achieve this object of the present invention, in an employment management system for the business system having a plurality of system apparatuses, a storage device stores unit configuration information, a plurality of methods constituting a common interface, and a program for each method. The common interface has at least a partial halt method for making the unit halt an operation of the business system and a partial restart method for making the unit restart the operation of the business system. When an arithmetic processing part performs employment operations by making a predetermined system apparatus halt the operation of the business system, the unit including the predetermined system is subjected to partial halt, employment operations and then partial restart.

According to the present invention, in the Web-based business system having a number of system apparatuses and software components, it is possible to reduce a load of configuration works and employment works of the business system and, facilitate of developments of employment designs and programs for the business system of non-stop 24 hours.

Other objects, features and advantages of the invention will become apparent from the following description of the embodiments of the invention taken in conjunction with the accompanying drawings.

### BRIEF DESCRIPTION OF THE DRAWINGS

FIG. 1 is a block diagram showing the overall configuration of an embodiment of the invention.

FIG. 2 is a diagram showing the system apparatus having a two-tier structure in FIG. 1.

FIG. 3 is a diagram showing the configuration of the system apparatus shown in FIG. 2 whose first tier is separated into two tiers to form a three-tier structure.

FIG. 4 is a diagram showing the structure of a plugin program file.

FIG. 5 is a diagram showing a common interface for the plug-in program.

FIG. 6 is a diagram showing the structure of a configuration definition table.

FIG. 7 is a diagram showing a system configuration pattern selection screen.

FIG. 8 is a diagram showing a load balancer definition screen.

FIG. 9 is a diagram showing a service environment definition screen.

FIG. 10 is a diagram showing a unit configuration definition screen.

FIG. 11 is a diagram showing a server machine definition table.

FIG. 12 is a diagram showing a system employment screen for daily employment operations.

FIG. 13 is a diagram showing a basic information table.

FIG. 14 is a diagram showing a load balancer definition table.

FIG. 15 is a diagram showing a tier common service environment definition table.

FIG. 16 is a diagram showing a unit configuration definition table.

FIG. 17 is a diagram showing a server machine definition table.

FIG. 18 is a diagram showing a service instance definition table.

FIG. 19 is a flow chart illustrating system configuration by a system configuration employment control processing part 117.

FIG. 20 is a flow chart illustrating system activation by the system configuration employment control processing part 117.

FIG. 21 is a flow chart illustrating work replacement by the system configuration employment control processing part 117.

FIG. 22 is a flow chart illustrating a process of implementing a method createServiceDefinitions of the plug-in program common interface for the configuration pattern shown in FIG. 3.

FIG. 23 is a flow chart illustrating a process of implementing a method setupServices of the plug-in program common interface for the configuration pattern shown in FIG. 3.

FIG. 24 is a flow chart illustrating a process of implementing a method deployApplilcations of the plug-in program common interface for the configuration pattern shown in FIG. 3.

FIG. 25 is a flow chart illustrating a process of implementing a method redeployApplilcations of the plug-in program common interface for the configuration pattern shown in FIG. 3.

FIG. 26 is a flow chart illustrating a process of implementing a method joinVirtualServer of the plug-in program common interface for the configuration pattern shown in FIG. 3.

### DESCRIPTION OF THE EMBODIMENTS

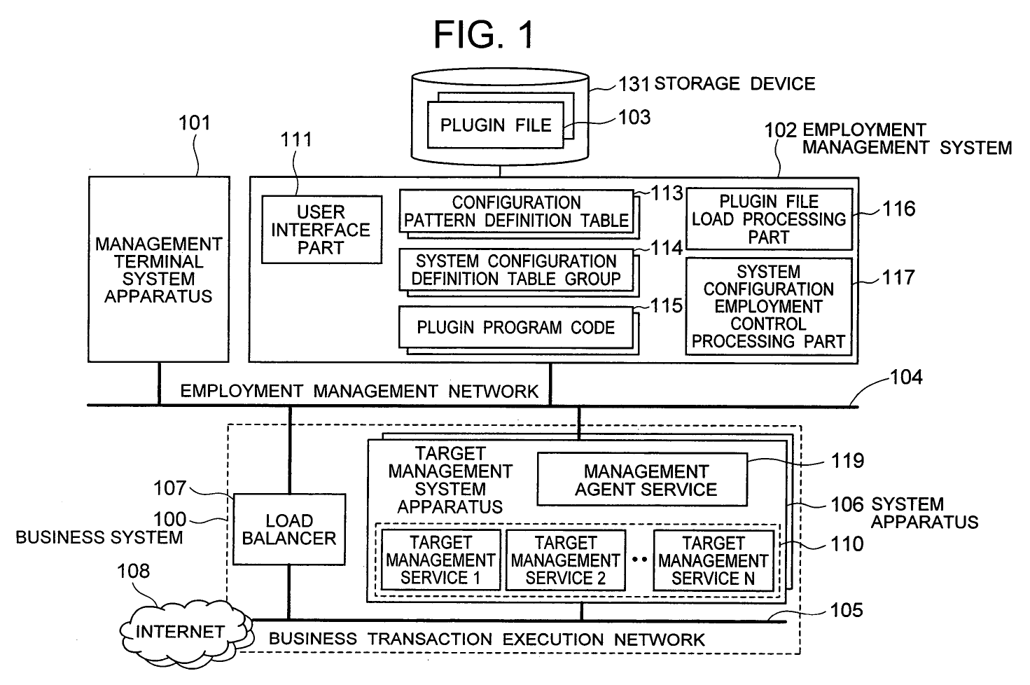

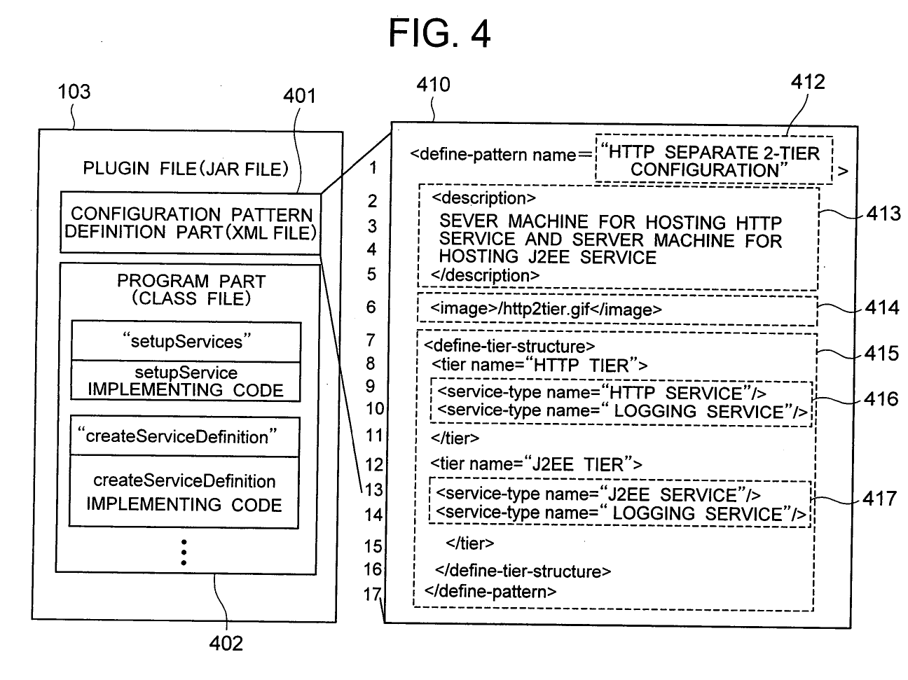

An employment management system for a business system according to an embodiment of the present invention will be described, first by describing the overall configuration and the business system configuration with reference to FIGS. 1 to 3, and then describing configuring and employing the business system with reference to FIGS. 4 to 26. Configuring the business system means works and processes to be performed before the start of service provision to end users and the like. Employment means, in a narrow sense, works and processes after the start of service provision, and in a broad sense, the concept including also configuring the business system.

1. Overall Configuration

FIG. 1 shows the overall configuration of the business system and the employment management system for managing the business system. By using a management terminal system apparatus 101, an employment manager connects the employment management system 102 to manage the business system 100. The employment management system 102 is constituted of a processor, a memory part, a communication part and the like, and can execute various processes, provision of definitions and the like by using modules such as a user interface part 111, a plugin file load processing part 116, a system configuration employment control processing part 117 and the like.

An employment management network 104 interconnects the management terminal system apparatus 101, employment management system 102 and business system 100. The business system 100 is also connected to a business transaction execution network 105, and data of business transactions is transmitted and received over a business transaction execution network 105. The business transaction execution network 105 is also connected to the Internet 108 and receives a business transaction of an end user via the Internet.

The business system 100 is constituted of a load balancer 107 and a plurality of target management system apparatuses 106 (hereinafter simply described as “system apparatus 106”). In this embodiment, although the load balancer 107 is used as a network apparatus by way of example, the invention is also applicable to other network apparatuses such as cache servers and firewalls. The load balancer 107 has a function of distributing data transmitted from the Internet 108 to a plurality of system apparatuses 106, and is constituted of a processor, a memory part, a communication part and the like. The load balancing function of the load balancer 107 may be assembled in each system apparatus 106, as software.

Although most of business systems 100 use DB servers, in this embodiment the employment management system 102 does not manage the DB server of the business system 100. However, the employment management approach of the present invention can be adopted to simplify the configuration employment of the DB server of the business system 100 because the DB server can be constituted of a plurality of system apparatuses of a parallel server arrangement. Further, in this embodiment, although the business system 100 is assumed to be a system on the J2EE base, the present invention is not limited to J2EE.

A plugin file 103 stores definition information of the configuration pattern of the system apparatus 106 of the business system 100 and employment programs (employment procedure programs), and is stored in a storage device 131 connected to the target management system apparatus 106 via the employment management system 102. The storage device 131 may be a magnetic disk, an optical disk or other devices capable of storing data. The storage device 131 may be structured integrally with the employment management system 102 as a portion thereof.

A plugin file load processing part 116 reads the plugin file 103 at a proper timing (e.g., when the employment management system 102 is activated), and develops the contents of the read plugin file into a configuration pattern definition table 113 and a plugin program code 115. If the function of the employment management system 102 is realized by Java (registered trademark), the plugin program code 115 is realized as a byte code on a Java (registered trademark) virtual machine, and stored in a heap (memory) of the Java (registered trademark) virtual machine. Each configuration pattern has its plugin file 103, and each plugin file 103 has its plugin program code 115.

Although there are a variety of topologies of the system apparatus 106 constituting the business system 100, these variations can be classified into typical configuration patterns. The topology of the system apparatus 106 in a unit and the arrangement of software components to be operated in the system apparatus have regularity specific to each configuration pattern. A common interface for fundamental employment operations independent from the configuration pattern is defined in advance for the unit, and an implementation program for a common interface formed in accordance with the configuration pattern in the unit is managed in correspondence with the definition information of the unit. The configuration and employment of the business system 100 can therefore be performed efficiently.

The description is reverted to the overall configuration. The system apparatus 106 is constituted of a processor, a memory, a disk storage, a network interface and the like. Running in this system apparatus are an operating system (OS) and a target management service group 110 including various services (processes) running on OS. In this embodiment, the “system apparatus” has the same meaning as that of a server, and the expressions “host” and “server machine” are used as having the same meaning.

In this embodiment, services include HTTP services for processing an HTTP protocol, J2EE services for realizing a J2EE function, logging services for collecting error information and performance information during service provision. In the system apparatus 106, in addition to the target management service group 110 for business, a management agent service 119 also runs. The management agent service 119 is software which operates while the employment management system 102 manages the business system 100.

There are a variety of employment management works for the business system 100. These works are mainly classified into two works: an initial configuration work (also including addition and deletion of a system apparatus after initial configuration) and a daily employment work.

The initial configuration work can be further classified into two works: a configuration work of the business system 100 at an infrastructural level and a configuration work at a business system level. The former configuration work at the infrastructural level includes settings of a network environment (settings of an IP address, VLAN, SLAN and the like and install of software such as OS and middleware, and the configuration work at the business system level is executed after the completion of the configuration work as the infrastructural level. The configuration work at the business system level includes setup of target management services (hereinafter described simply as “services”), distribution of setting information, deployment of business applications (hereinafter described simply as “applications”) and the like. The daily employment work includes service setting change, application version-up, system plan stop/start and the like.

This embodiment realizes simplification/semi-automation of the initial configuration work at the business system level and the daily employment work. The prior art described in Patent Document 1 or preliminary manual works may be applied to the configuration work at the infrastructural level.

The following description is directed to the main flow of configuration employment of the business system 100 by a manager using the employment management system 102.

First, the manager supplies system configuration definitions of the business system 100 via the user interface part 111, and stores the definition information in a system configuration definition table group 114. Next, the manager supplies the user interface part 111 with a command for execution of environment configuration and employment of the business system 100. The user interface part 111 sends the command to the system configuration employment control processing part 117. In accordance with the information of the system configuration definition table group 114, the system configuration employment control processing part 117 controls the plugin program code 115, to transmit command strings and setting files necessary for the environment configuration and employment to the load balancer 107 or system apparatus 106.

In the system apparatus 106, the management agent service 119 receives the command strings and setting files, and executes a command for environment configuration and employment operation, relative to the target management service group 110 in the system apparatus 106. For example, if service is HTTP service, there are httpd.conf for the setting file and an HTTP service start/stop command for the employment operation command.

A suitable method for realizing the management agent service 119 may be FTP (File Transfer Protocol) for transmission/reception of the setting file, and Telnet or the like for issuance of the employment operation command string.

A suitable example of the load balancer 107 has a means of transmission/reception of the command string and the setting file. The typical means of transmission/reception of the command string is Telnet or the like. The typical means of transmission/reception of the setting file is FTP, TFTP (Trivial File Transfer Protocol) or the like.

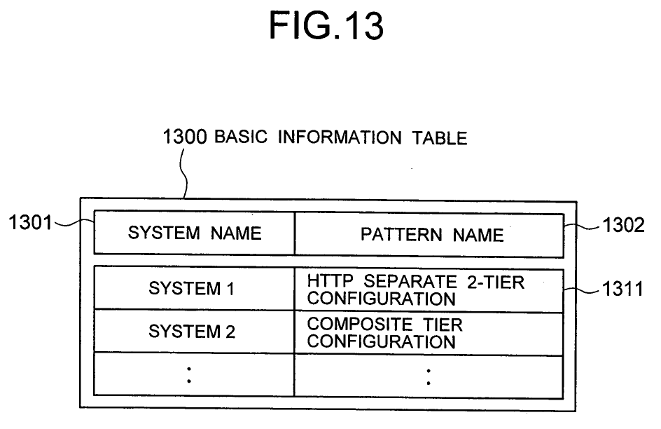

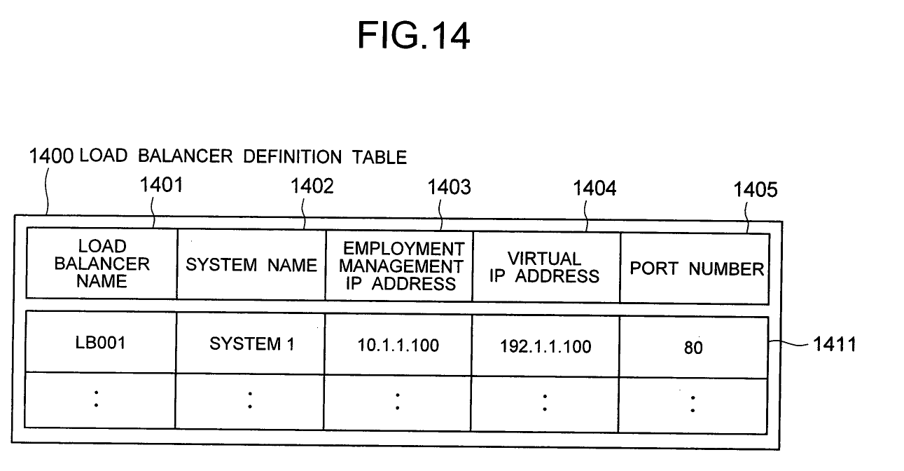

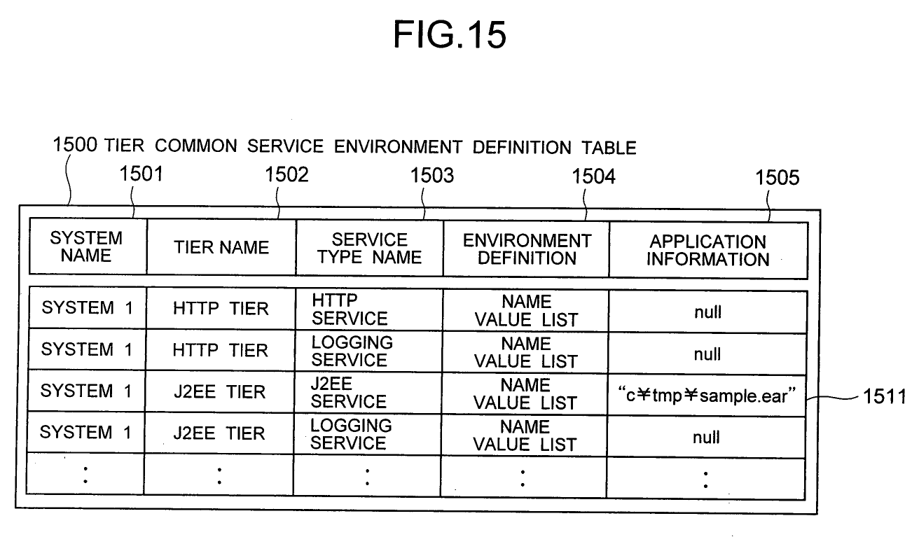

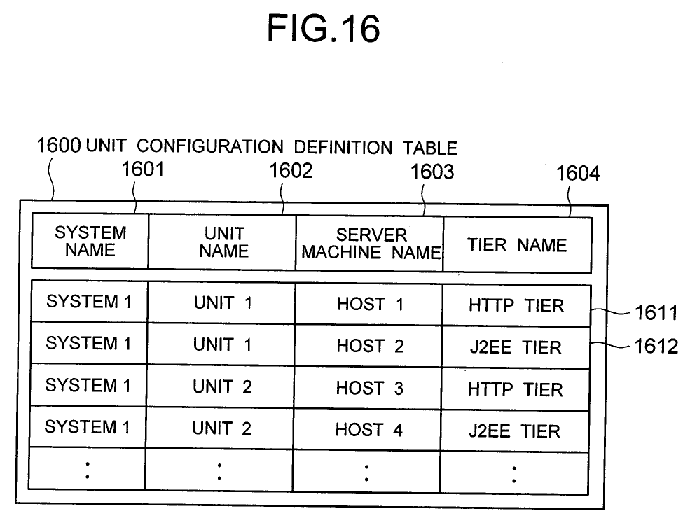

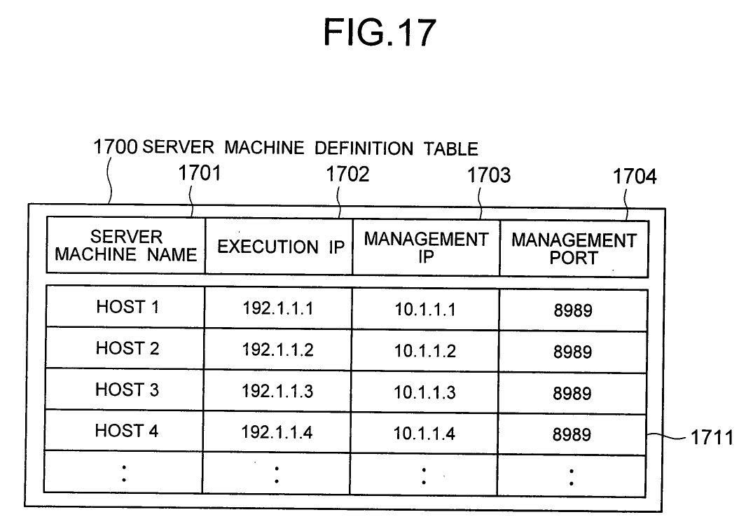

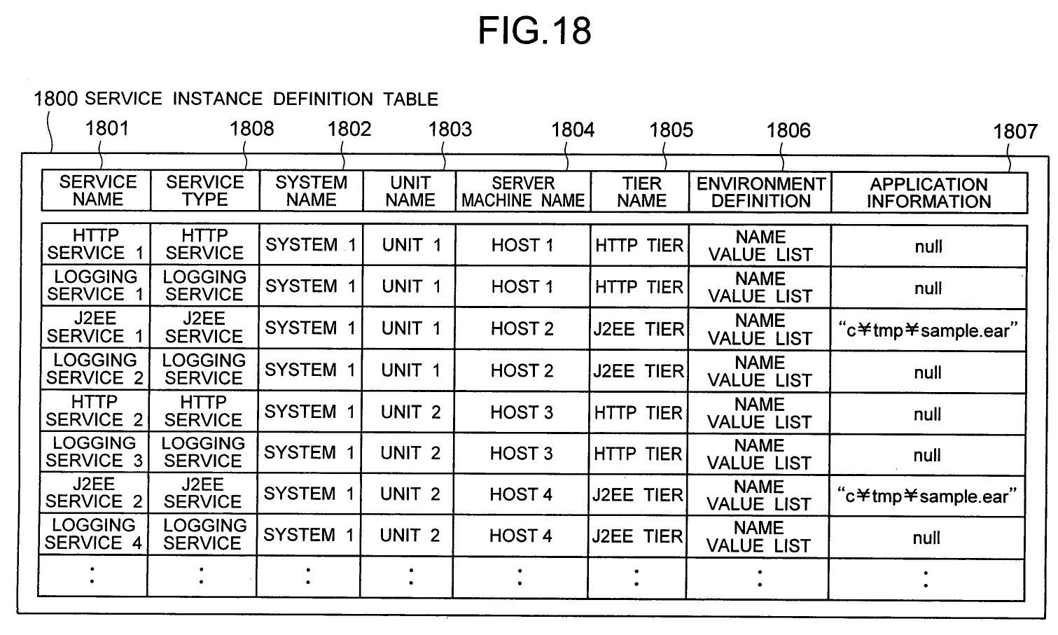

The system configuration definition table group 114 is constituted of a basic information table 1300 (FIG. 13), a load balancer definition table 1400 (FIG. 14), a tier common service environment definition table 1500 (FIG. 15), a unit configuration definition table 1600 (FIG. 16), a server machine definition table 1700 (FIG. 17) and a service instance definition table 1800 (FIG. 18).

2. Configuration Pattern and Concept of Unit

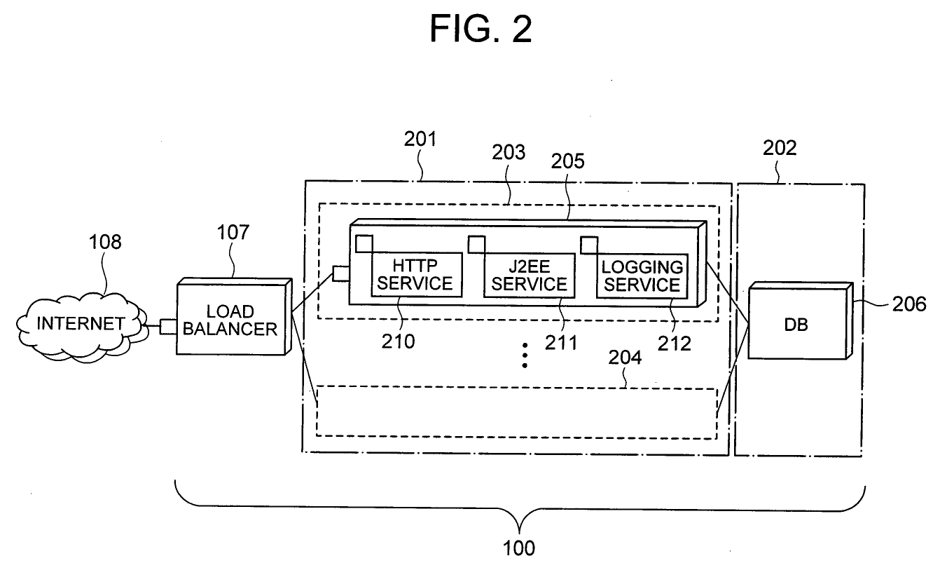

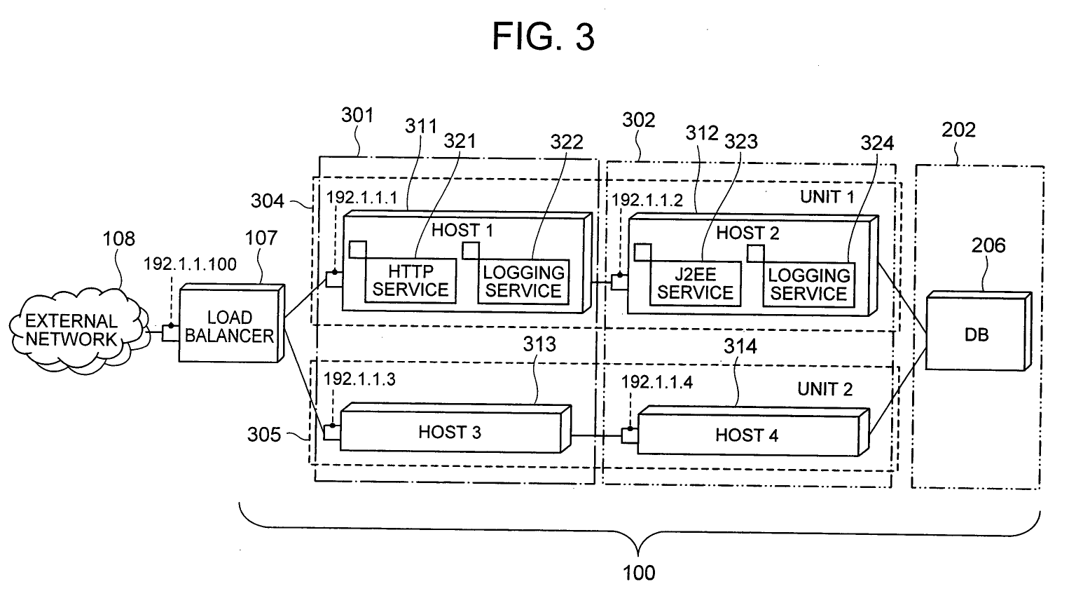

With reference to FIGS. 2 and 3, description will be made on variations of the configuration pattern of the business system 100 and the concept of the unit capable of lock-out, respectively assumed in this embodiment.

FIG. 2 shows the fundamental pattern of the business system 100 having a two-tier structure. The first tier 201 has a system apparatus 205 of the cluster structure running HTTP service, J2EE service and logging service.

The second tier 202 is a data tier and has a system apparatus 206 for DBMS. DBMS may have a cluster structure by using a plurality of system apparatuses. The load balancer 107 performs load distribution to the first tier 201. The system apparatuses 205 and 206 each correspond to the system apparatus 106 shown in FIG. 1.

Additional description will be made on the definition of the tier described earlier. The tier is a collection of system apparatuses having the function of the same kind. The system apparatus belonging to a particular tier runs the services of the same kind under the same configuration (settings).

In connection with this tier concept, a collection of the system apparatus 205 and the target management service group 210, 211 and 212 running on the system apparatus is called a unit. The features of the unit reside in that even if a particular unit is halted, the whole business system 100 will not be halted but operates in the degenerating mode. When the business system 100 having the configuration shown in FIG. 2 is to be maintained non-stop for 24 hours, it is sufficient to repeat halt, maintenance and restart in the unit basis. Therefore, the unit is a portion constituting the business system 100 and is defined as the unit capable of being halted and restarted, without halting the whole business system 100.

FIG. 3 shows the configuration of a three-tier structure separating the first tier 201 shown in FIG. 2 into two tiers and having a connection of 1:1 between the apparatuses at first and second tiers 301 and 302. The first tier 301 is a collection (called HTTP tier) of system apparatuses 311 and 313 running HTTP services and logging services, and the second tier 302 (called J2EE tier) is a collection of system apparatuses 312 and 314 running J2EE services and logging services. The system apparatuses 311 to 314 each correspond to the system apparatus 106 shown in FIG. 1.

A third tier 202 has a system apparatus 206 for DBMS similar to that shown in FIG. 2. The system apparatuses 311 and 312 and the target management service group 321 to 324 running on the system apparatuses constitute a unit 304 capable of partial regeneration. As compared to the structure shown in FIG. 2, the characteristic point of the structure shown in FIG. 3 is tier-transverse, namely, the unit has both the system apparatuses at the first and second tiers 301 and 302. The business system 100 shown in FIG. 3 is constituted of two units, the units 304 and 305.

The connection between the apparatuses at the first and second tiers 301 and 302 includes three variations: N:1, 1:N, and M:N, in addition to 1:1(FIG. 3).

In the case of N:1, a plurality of system apparatuses at the first tier 301 are connected to one system apparatus at the second tier 302, one unit is constituted of one system apparatus at the second tier 302 and a plurality of system apparatuses at the first tier 301 connected to the one system apparatus, and a plurality of units constitute the business system 100.

In the case of 1:N, one system apparatus at the first tier 301 is connected to a plurality of system apparatuses at the second tier 302, and one unit is constituted of one system apparatus at the first tier 301 and a plurality of system apparatuses at the second tier 302 connected to the one system apparatus. One system apparatus at the first tier 301 is required to perform load distribution to the plurality of system apparatuses so that settings/employment different from N:1 are necessary.

In the case of M:N, a desired number of system apparatuses at the first tier 301 are each connected to all system apparatuses at the second tier 302. Each of the system apparatuses at the first tier 301 performs load distribution to all the system apparatuses at the second tier 302. Since the first and second tiers 301 and 302 are interconnected by a mesh, each system apparatus at the first and second tiers 301 and 302 can halt independently so that the whole business system 100 is capable of partial degeneration. Each of the system apparatuses at the first and second tiers constitutes, therefore, one unit.

There are variations of the arrangement of services of the system apparatuses at the first and second tiers 301 and 302. J2EE service is generally constituted of two functions: a Web container function and an EJB (Enterprise Java (registered trademark) Beans) container function. The variations are therefore the system apparatus at the first tier 301 running HTTP service and J2EE service as the Web container, and the system apparatus at the second tier 302 running HTTP service and J2EE service as the EJB container.

As the configuration having enhanced usability, the configuration (fail over configuration) is used which, for example, the system apparatus 205 shown in FIG. 2 is not realized by a single apparatus but realized by two system apparatuses of an active system and a standby system. In the variation of the fail over configuration which is an extended configuration of that shown in FIG. 2, each of the units 203 and 204 is constituted of two system apparatuses of the active system and standby system.

As described above, by stipulating the unit as the management unit, any of a variety of business systems 100 can be normalized as a collection of a plurality of units. Since the unit is an abstract portion of the business system capable of partial lock-out and restart, when a particular unit halts, the business system 100 operates in a degenerated mode by using the remaining units excluding the halted unit and the business system 100 will not halt as a whole. The configuration of the unit differs depending upon the configuration pattern of the business system.

In the above description of the embodiment, as the variations of the configuration pattern of the business system 100, description has been made on the variations of the multitier configuration of system apparatuses, the intertier connection topology in the multitier configuration, the service arrangement of system apparatuses and the fail over configuration of apparatuses. Other conceivable variations include the fail over configuration of the load balancer 107, the DB partitioning configuration, and the configuration of a J2EE server apparatus matching the DB partitioning configuration, and the concept of the unit is also applicable to these variations.

The features of the present invention reside in that of a variety of configuration patterns of the business system 100, the employment program for 24-hour non-stop employment can be generalized as the system configuration employment control processing part 117 and the portion dependent upon the configuration pattern in the unit can be localized as the plugin file 103, by providing the tier-traverse management unit called the unit and using a common interface 501 constituted of each method. By generalizing the employment logic at the system level (a unit larger than the unit) and localizing the operation in the unit, a new configuration pattern can be dealt with by partial addition of the localized employment logic.

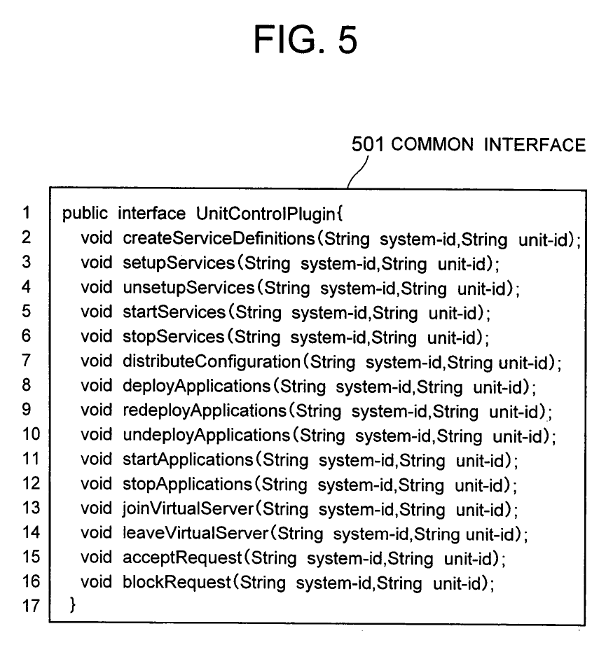

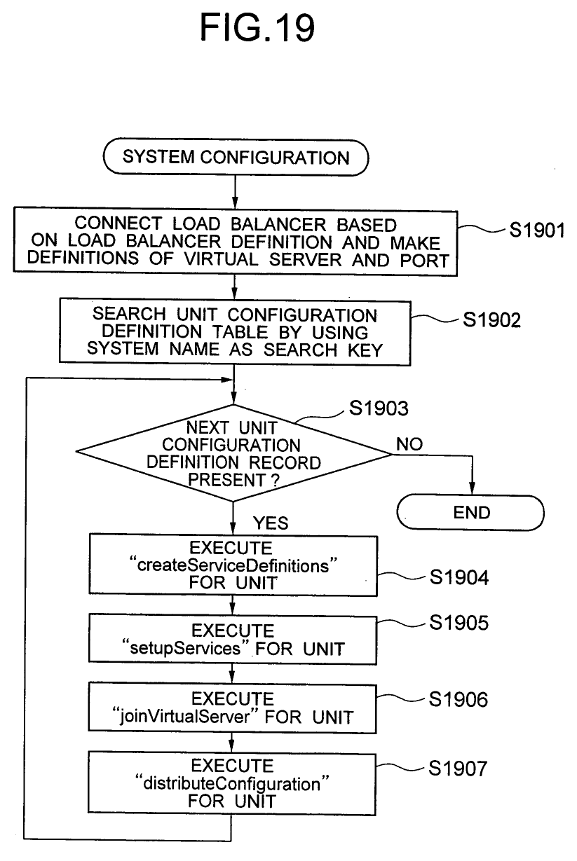

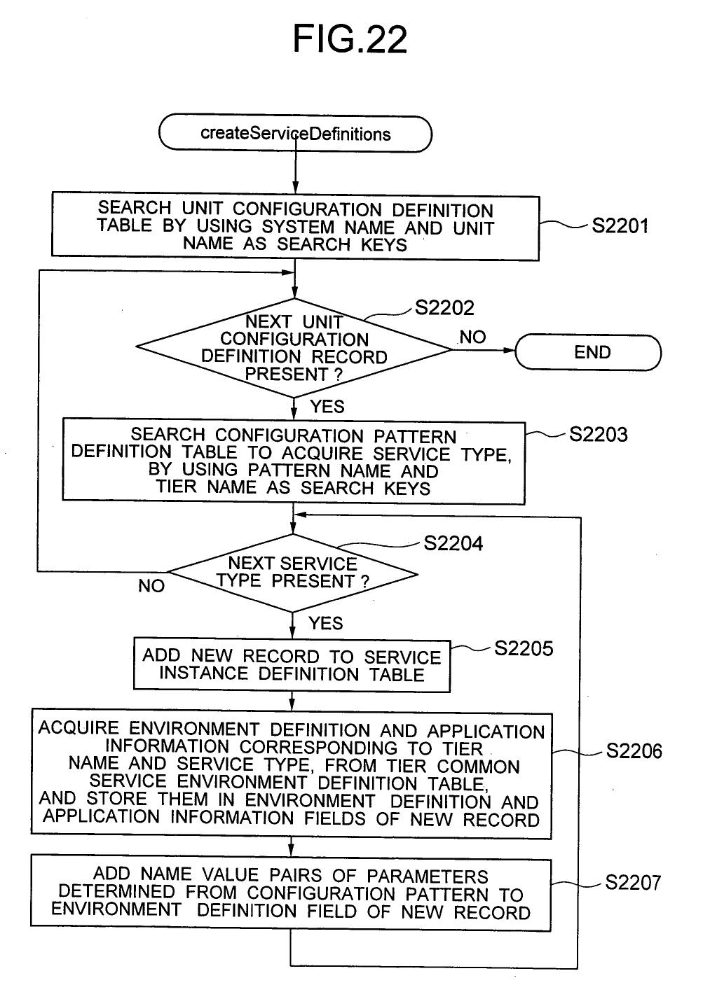

The following description will be made by taking as an example the configuration of the business system 100 shown in FIG. 3, in the order of the structure of the plugin file 103 (FIG. 4), the structure of the system configuration definition and the definition procedure (FIG. 5 to FIG. 18), a common process flow of the employment logic at the system level independent from the configuration pattern (FIG. 19 to FIG. 21) and the process flow of the employment logic dependent upon the configuration pattern (FIG. 22 to FIG. 26: the implemented portion of the plugin program).

3. Structure of Plugin File and its Load Process

FIG. 4 shows the structure of the plugin file 103 and an example of the configuration pattern definition.

The plugin file 103 is constituted of: a configuration pattern definition part 401 for holding meta information of the configuration pattern; and a program part 402 implementing the employment operation of a unit suitable for the configuration pattern. The configuration pattern definition part 401 is a text file based on XML (Extensible Markup Language), and its specific example is a configuration pattern definition 410. The left numerals of the configuration pattern definition is the row numbers in the definition file. A specific example of the program part 402 is a Java (registered trademark) class file output by compiling a Java (registered trademark) source program implementing a Java (registered trademark) interface shown in FIG. 5, with a Java (registered trademark) compiler. The plugin file 103 is a file (Jar file) obtained by archiving the text file in the configuration pattern definition part 401 and the class file in the program part 402 in a Java (registered trademark) Archive format.

Next, the configuration pattern definition 410 will be described. The first row 412 designates a configuration pattern name of the configuration pattern, and the second to fifth rows 413 describe the features of the configuration pattern in a natural language. The sixth row 414 designates path information of an image file which is used, when a GUI tool cooperates, for displaying an image representative of the features of the configuration pattern on the GUI tool. The image file is bundled with the plugin file 103, and the path information designates the location in the archive file where the image file exists.

The seventh to seventeenth rows 415 define the structure of each tier. The configuration pattern shown in FIG. 3 is constituted of the first tier 301 called an “HTTP tier” and the second tier 302 called a “J2EE tier”. It is defined at 416 that the system apparatus belonging to the HTTP tier 301 runs HTTP service and logging service, and it is defined at 417 that the system apparatus belonging to the J2EE tier 302 runs J2EE service and logging service.

FIG. 5 shows an example of implementation of the program part 402 showing the common interface 501 which is a Java (registered trademark) interface for unit employment operation. The left numerals of the command interface 501 represent the row numbers of the interface definition. The common interface 501 is an employment operation interface defined in common for a variety of configuration patterns of the business system 100 described with FIGS. 2 and 3. Implementation of the common interface 501 differs for each configuration pattern. All operations basically designate the system name and the unit name of the target system as arguments. The system name is designated by a first argument system-id and the unit name is designated by a second argument unit-id.

Brief description will be made on the function of each method of the common interface 501. A method at the second row, createServiceDefinitions, automatically generates definition information of services in the unit based on the configuration pattern of the business system 100. A method at the third row, setupServices, sets up a service group based on the service arrangement of the configuration pattern. A method at the fourth row, unsetupServices, deletes the service set up by the third row method setupServices. A method at the fifth row, startServices, starts the service group in the unit. A method at the sixth row, stopServices, stops the service group in the unit. A method at the seventh row, distributeConfiguration, distributes the setting file to the system apparatus 106. A method at the eighth row, deployApplications, deploys applications to the services in the unit. A method at the ninth row, redeployApplications, redeploys applications to the services in the unit.

A method at the tenth row, undeployApplications, undeploys the applications from the services in the unit. A method at the eleventh row, startApplications, starts applications deployed to the unit. A method at the twelfth row, stopApplications, stops the applications deployed to the unit. A method at the thirteenth row, joinVirtualServer, joins a unit to be balanced by the load balancer 107. A method at the fourteenth row, leaveVirtualServer, deletes a unit to be balanced by the load balancer 107. A method at the fifteenth row, acceptRequest, routes a user transaction received at the load balancer 107 via the Internet 108 to the system apparatus 106 in the unit. A method at the sixteenth row, blockRequest, stops routing a user transaction received at the load balancer 107 via the Internet 108 to the system apparatus 106 in the unit.

The common interface 501 is constituted of these methods and stored in the storage device 131.

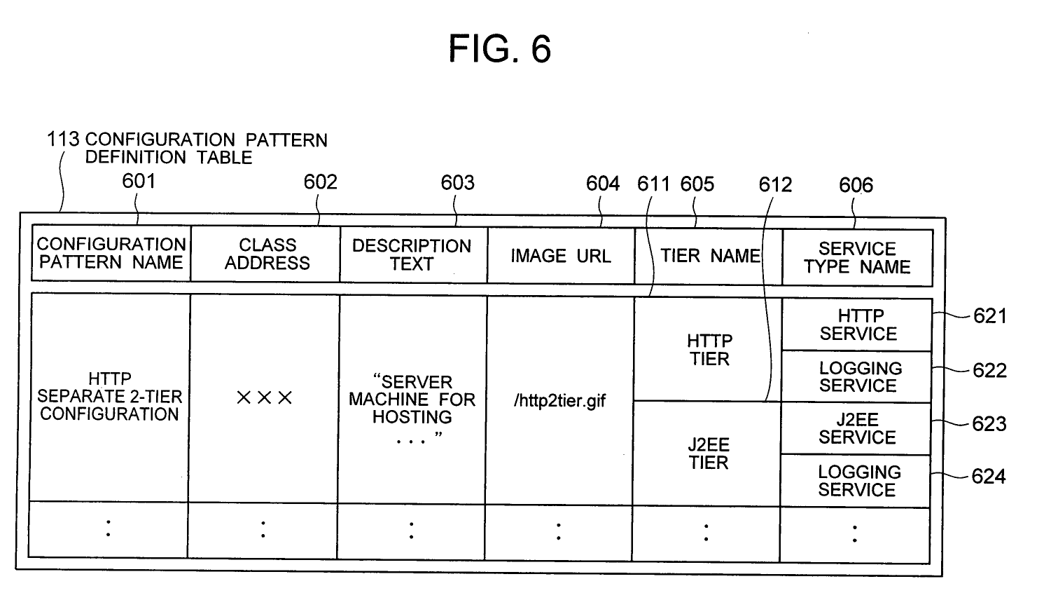

FIG. 6 shows the details of the configuration pattern definition table 113. The configuration pattern definition table 113 is constituted of six fields (columns) including a configuration pattern name field 601, a class address field 602, a description text field 603, an image URL field 604, a tier name field 605 and a service type name field 606.

The configuration pattern name field 601 corresponds to the pattern name 412 shown in FIG. 4. The class address field 602 holds address information of the plugin program code 115 on a heap of a Java (registered trademark) virtual machine. The description text field 603 corresponds to the description 413 shown in FIG. 4. The image URL field 604 corresponds to the image 414 shown in FIG. 4. The tier name field 605 corresponds to the definition fragment 415 shown in FIG. 4. The definition fragment 415 indicates that the system is constituted of two tiers which are developed into records 611 and 612. The service type field 606 corresponds to the service types 416 and 417 shown in FIG. 4 and is developed into records 621 and 622 and records 623 and 624.

The following description relates to the load procedure of the plugin file 103 by the plugin file load processing part 116. First, a file list is acquired from the storage device 131 under a specific directory. Next, the plugin file 103 is read for each file in the acquired file list, the configuration pattern definition 410 is developed in the configuration pattern definition table 113, the class file in the program part 402 is developed as a byte code (class) on the heap of the java (registered trademark) virtual machine (VM), and its address information is set to the class address field 602 of the configuration pattern definition table 113.

4. Screens and Procedure of System Configuration Definitions by Manager

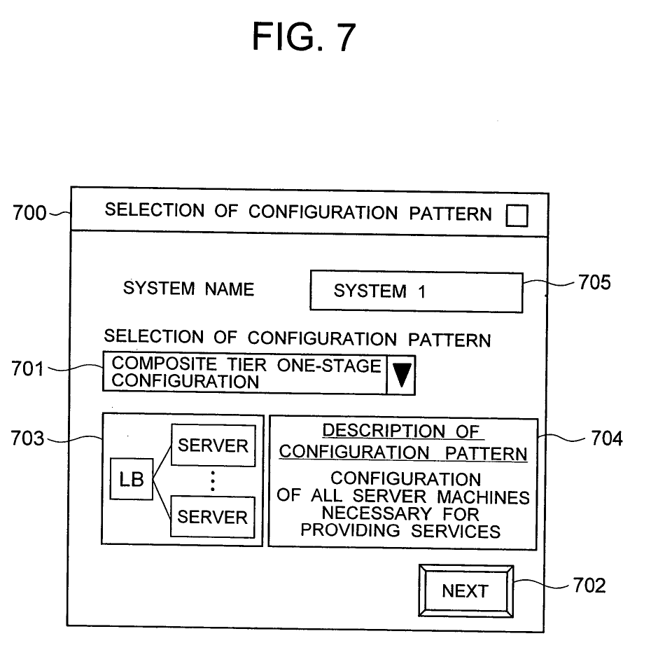

FIGS. 7 to 12 illustrate the procedure of system configuration definitions by a manager. The information defined by the manager is stored in the table group shown in FIGS. 13 to 17. Screens are controlled by the user interface part 111.

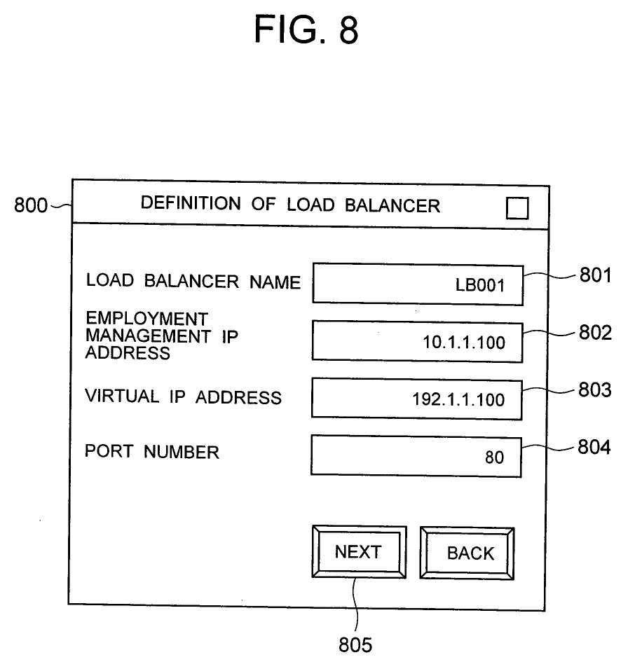

FIG. 7 shows a system configuration pattern selection screen 700. The employment management system 102 displays a list of pattern names (field 601) stored in the configuration pattern definition table 113 as a pull-down menu 701. The manager selects a proper configuration pattern name from the pull-down menu 701, inputs the system name in the text field 705, clicks a button 702 for transition to the next screen, load balancer definition screen 800 (FIG. 8). In the case of the business system 100 shown in FIG. 3, the proper configuration pattern name to be selected from the pull-down menu 701 is “HTTP separate 2-tier configuration”. An image 703 and a descriptive sentence 704 correspond to the image URL field 604 and description text field 603 of the configuration pattern definition table 113, respectively.

User input information to the system configuration pattern selection screen 700 is stored in the basic information table 1300 shown in FIG. 13. The name in the text field 705 is stored in a system name field 1301 of the table 1300, and the configuration pattern name selected from the pull-down menu 701 is stored in a pattern name field 1302.

A record 1311 indicates that the system name of the business system 100 shown in FIG. 3 is “system 1” and the system belongs to the configuration pattern “HTTP separate 2-tier configuration”. By using the name in the configuration pattern name field 1302 as a search key, the configuration pattern definition table 113 is searched to refer to the meta information of the configuration pattern.

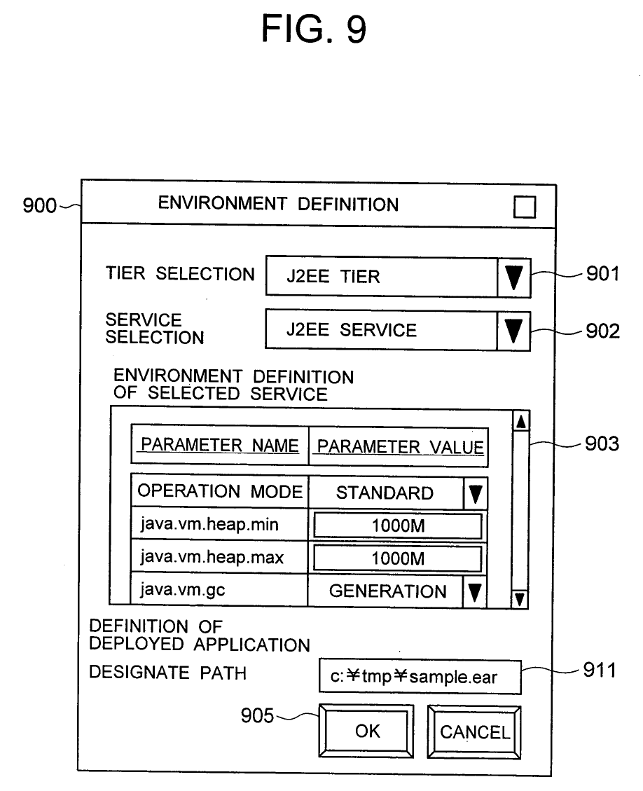

FIG. 8 shows the load balancer definition screen 800 for the load balancer 107. The manager inputs a logical name 801 and an employment IP address 802 of the load balancer 107 and an IP address 803 and a port number 804 of the virtual server, and clicks a button 805 for transition to the next screen, service environment definition screen 900 (FIG. 9). The employment management IP address 802 is used when the employment management system 102 connects the load balancer 107 to issue an employment management command string to the load balancer 107. The IP address 803 of the virtual server is a so-called VIP (Virtual IP) which is used when an end user connects the business system via the Internet 108.

User input information to the load balancer definition screen 800 is stored in the load balancer definition table 1400 shown in FIG. 14. The logical name 801, employment management IP address 802, virtual server IP address 803 and virtual server port number 804 are stored in a load balancer name field 1401, an employment management IP address field 1403, a virtual IP address field 1404 and a port number field 1405 of the table 1400, respectively. The name (at 705) of the system being defined is stored in a system name field 1402. An input example to the load balancer definition screen 800 shown in FIG. 8 is stored as a record 1411.

FIG. 9 shows the service environment definition (parameter definition) screen 900 common to all tiers. As shown in FIG. 3, if services in different units belong to the same tier, the parameter definitions for these services are fundamentally the same. For example, it is necessary to define J2EE services belonging to the second tier 302 shown in FIG. 3 for the units 304 and 305. However, since the two services have the common environment definition (parameter definition), the service is defined collectively in the unit of a service type. Not all parameters are not defined collectively in the unit of the service type, but the parameters may have different values dependent upon an individual instance determined by the topology. The solving method for those parameters determined by the topology and configuration will be described in connection with createServiceDefinitions in FIG. 22.

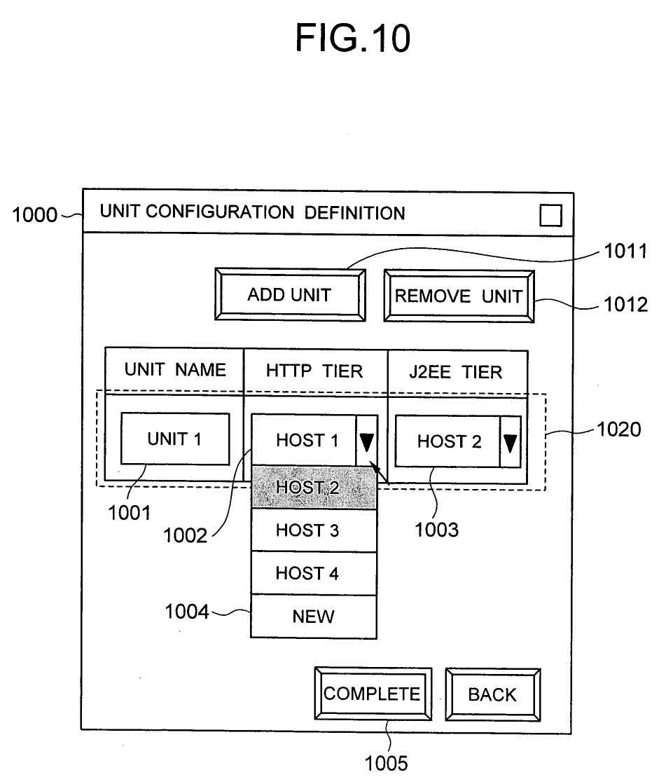

In the service environment definition screen 900 shown in FIG. 9, a tier to be defined and a service type are selected from menus 901 and 902, and the environment definition is made collectively for each service type. FIG. 9 shows the screen in which the environment definition common to J2EE services at the J2EE tier (corresponding to a filed 903) is performed. The environment definition is made by inputting or selecting a proper value for each of various parameters. If the type of service whose environment is to be defined is J2EE service, it is necessary to further designate a J2EE application so that a file path of the J2EE application is designated in a field 911. If the environment definition of services at all tiers is completed, a button 905 is clicked for transition to the next screen, unit configuration definition screen 1000 (FIG. 10).

User input information to the service environment definition screen 900 is stored in the tier common service environment definition table 1500 shown in FIG. 15. The system name 705 of the system being defined is stored in a system name field 1501 of the tier common service environment definition table 1500. Information of the tier whose environment is to be defined and the service type selected from the menus 901 and 902 is stored in a tier name field 1502 and a service type name field 1503, respectively. Parameter definition information defined in the field 903 is stored in an environment definition field 1504 as a list of name value pairs each constituted of a parameter name and an input value. Application information defined in a field 911 is stored in an application information field 1505.

An input example to the service environment definition screen 900 shown in FIG. 9 is stored as an upper third record 1511. The definition in the record 1511 is only the definition common to J2EE services in the unit at the J2EE tier 302, and the environment definition for an individual service instance (e.g., individual environment definition for the J2EE service 323) is made by the method createServiceDefinitions to be described with FIG. 22 in accordance with the contents of the record 1511.

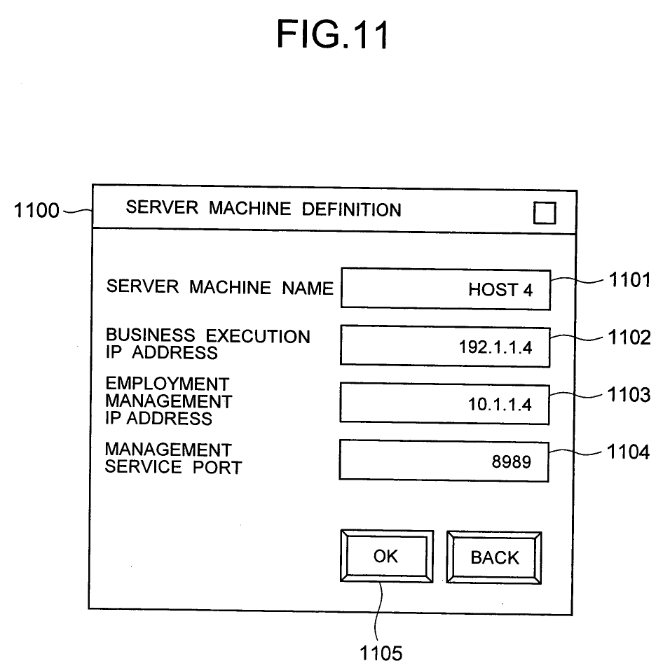

FIGS. 10 and 11 show screens with which the unit configuration and the arrangement of system apparatuses are defined. In a unit configuration definition screen 1000 shown in FIG. 10, a button 1011 is clicked to add a new unit, and a button 1012 is clicked to delete a unit.

When a unit is to be added, a new row 1020 is added. The screen shown in FIG. 10 is obtained immediately after the button 1011 is clicked in the state that no unit is defined. After the row 1020 is added, a unit name of a new unit is input to a unit name field 1001, and one system apparatus is selected from each of system apparatus selection pull-down menus 1002 and 1003, for the system apparatuses at the HTTP tier and J2EE tier. With the above operations, the unit 304 shown in FIG. 3 is defined as “unit 1”, and the unit 305 is defined in the similar manner.

User input information to the unit configuration definition screen 1000 is stored in the unit configuration definition table 1600 shown in FIG. 16.

As the unit name 1001 is designated and two server machines 1002 and 1003 to be arranged in the new unit are selected, new two records are added to the unit configuration definition table 1600. For each of the two additional records, the value of the system name 705 of the system to be defined is stored in a system name filed 1601, a value designated by the unit name 1001 in the unit configuration definition screen 1000 is stored in a unit name field 1602, the name of the selected server machine (a value at 1002 or a value at 1003) is stored in a server machine name field 1603, and the name of a tier to which the server machine belongs (“HTTP tier” for the value at 1002 or “J2EE tier” for the value at 1003) is stored in a tier name field 1604. The new records added to the input example of the unit configuration definition screen 1000 shown in FIG. 10 correspond to records 1611 and 1612.

If a desired system apparatus is not defined in advance in the pull-down menus 1002 or 1003, a “new” 1004 is selected from the pull-down menu for transition to the server machine definition screen (FIG. 11) with which the new system apparatus is defined. The definition of a system apparatus is constituted of: a server machine name 1101 which is a logical name of the system apparatus; a business execution IP address 1102 which is an IP address in the business transaction execution network 104; an employment management IP address 1103 which is an IP address in the employment management network 104; and an employment service port number 1104 which is a port number of the management agent service 119.

User input information to the server machine definition screen 1100 is stored in the server machine definition table 1700 shown in FIG. 17. A server machine name 1101, a business execution IP address 1102, an employment management IP address 1103 and an employment service port number 1104 in the service machine definition screen 1100 shown in FIG. 11 are stored in a server machine name field 1701, and execution IP field 1702, a management IP field 1703, and a management port 1704 of the server machine definition table 1700, respectively. An input example to the server machine definition screen 1100 shown in FIG. 11 is stored as a record 1711. With the above operations, the business system 100 can be defined as the business system 100 having the configuration shown in FIG. 3. Next, description will be made on the configuration management processes for the business system 100 based on these definitions.

5. Configuration Management Logic at System Level:

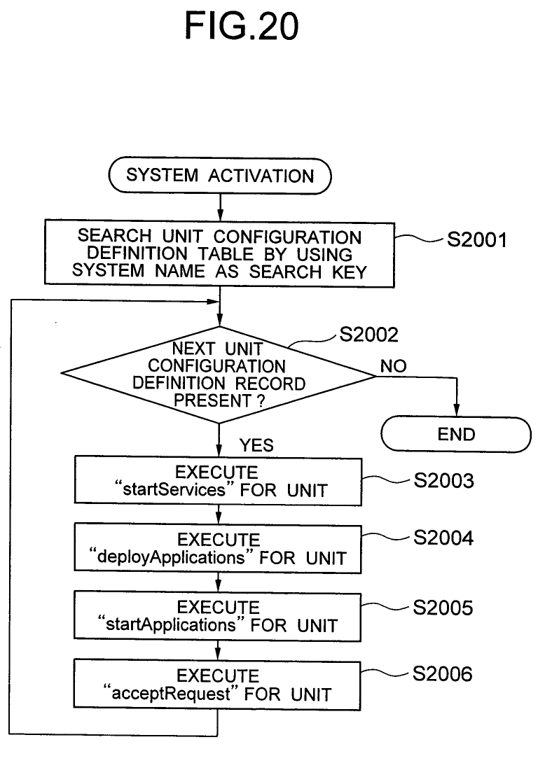

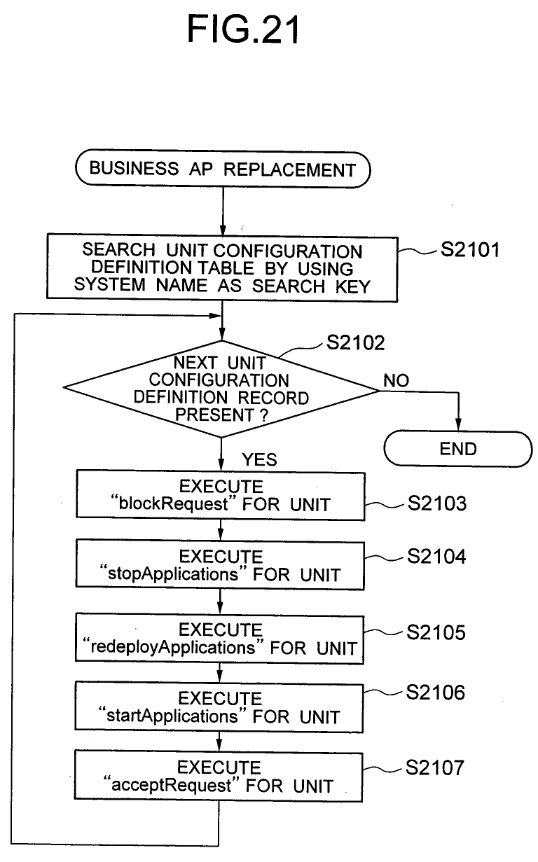

process flow by the system configuration employment control processing part 117 FIGS. 19 to 21 illustrate the configuration employment procedure (processes by the system configuration employment control processing part 117) for the business system 100, which procedure is a general-purpose procedure using the common interface 501 and is independent from the configuration of the business system 100. FIGS. 19 and 20 illustrate the processes for configuring the business system 100, and FIG. 21 illustrates the employment processes for the business system 100. A process of each method (FIG. 5) in the procedure illustrated in FIGS. 19 to 21 will be described by referring to FIGS. 22 to 26.

Referring to FIGS. 19 to 21, the system configuration employment control processing part 117 activates the methods of the common interface 501. The activation procedure includes acquiring the pattern name to which the business system 100 to be operated belongs to, from the pattern name field 1302 of the basic information table 1300 and acquiring the class address of the implementing class of the common interface 501 corresponding to the pattern name, from the class address field 602 of the configuration pattern definition table 600. The method for the implementing class is called by using a Reflection function of the Java (registered trademark) language.

FIG. 19 is a flow chart illustrating the configuration procedure for the business system 100 to be executed by the system configuration employment control processing part 117. This procedure is executed in response to an event that the button 1005 shown in FIG. 10 is clicked. As this procedure is executed, setup of various services of the system apparatus and environment settings are completed and the business system 100 enters the state of being activated.

First, definition information is acquired from the load balancer definition table 1400 by using as search keys the names of the system apparatuses 311 to 314 to be configured. In accordance with the load balancer definition, the load balancer 107 is connected to make the definitions of a virtual server and its port. Namely, a command string for instructing to make the definitions of the virtual server and its port is transmitted to the load balancer 107 connected by using the employment management IP address 1403 (Step S1901). A suitable example of the load balancer 107 has a means for defining the virtual server by using the virtual IP address 1404 and port number 1405 as arguments. Next, units are searched from the unit configuration definition table 1600 by using as a search key the name of the system to be configured (Step 1902). For each searched unit (if Yes at Step 1903, and for each of the “unit 1” and “unit 2” in the case shown in FIG. 16), Steps 1904, 1905, 1906 and 1907 are executed.

For each unit, the method createServiceDefinitions of the common interface 501 is executed (Step 1904) to create the service instance definition table. Next, the method setupServices of the common interface 501 is executed (Step 1905) to set up services of the system apparatus 106 in accordance with the definitions created at Step 1904. Next, the method joinVirtualServer of the common interface 501 is executed (Step 1906) to add the services to be balanced by the load balancer 107 among the services set up at Step 1905, to the load balancer 107. Lastly, the method distributeConfiguration of the common interface 501 is executed (Step S1907) to generate the configuration file from the environment definition information created at Step 1904 and send this file to the services set up at Step 1905.

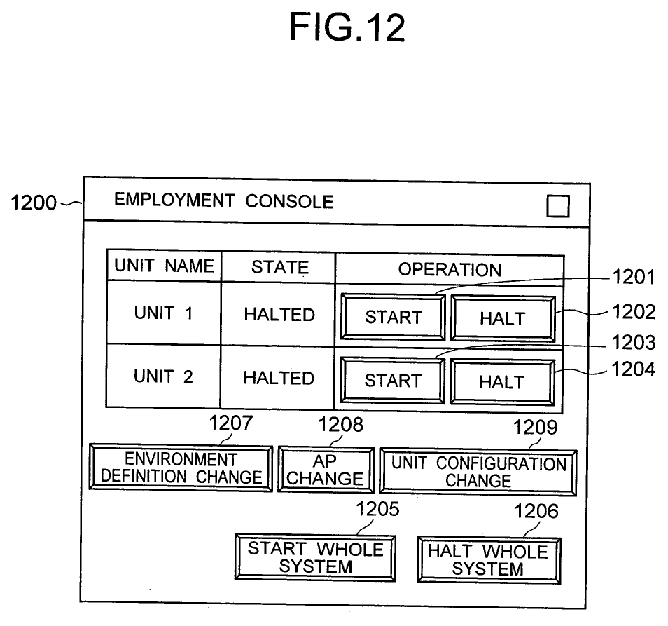

FIG. 20 is a flow chart illustrating the activation procedure for the business system 100 to be executed by the system configuration employment control processing part 117. This procedure is executed in response to an event that the button 1205 shown in FIG. 12 is clicked. As this procedure is executed, activation of various services in the system apparatus and deployment of applications are performed, and the business system 100 receives a request from an end user.

First, units are searched from the unit configuration definition table 1600 by using as a search key the name of the system to be activated (Step 2001). For each searched unit (if Yes at Step 2002, and for each of the “unit 1” and “unit 2” in the case shown in FIG. 16), Steps 2003, 2004, 2005 and 2006 are executed.

For each unit, the method startServices of the common interface 501 is executed (Step 2003) to start services in the unit. Next, the method deployApplications of the common interface 501 is executed (Step 2004) to deploy applications for the services in the unit. Next, the method startApplications of the common interface 501 is executed (Step 2005) to start applications for the services in the unit. Lastly, the method acceptRequest of the common interface 501 is executed (Step S2006) to start accepting a request from an end user.

FIG. 20 illustrates the activation procedure for the business system 100. A halt procedure for the business system 100 is similar to that shown in FIG. 20. In halting the business system 100, as the button 1206 shown in FIG. 12 is clicked, the system configuration employment control processing part 117 starts executing processes of reversed operations in the reversed order of the activation procedure, i.e., the methods blockRequest, stopApplications and stopServices, instead of Steps 2003, 2004, 2005 and 2006 shown in FIG. 20. However, the method undeployApplications which is a reverse operation of the method deployApplications is not executed.

With the above operations, the configuration process for the business system 100 is completed, and thereafter the screen is subjected to transition to the system employment screen 1200 (FIG. 12, description will be later given) to start the employment process by the system configuration employment control part 117. The employment operation includes a partial halt (button 1202 or 1204) and a partial restart (button 1201 or 1203) respectively in the unit basis, a whole system start (button 1205) and a whole system halt (button 1206). As each button is clicked, the system configuration employment control processing part 117 starts a corresponding process.

In addition to the above-described basic employment operations, there are parameter change, business application change (replacement including version-up), unit configuration change (unit addition and deletion) and the like. These change operations are executed by the system configuration employment control processing part 117 which effects change definition after transition to the screen shown in FIG. 9 or 10 as each of the buttons 1207, 1208 and 1209 is clicked.

Next, description will be made on the employment procedure for the business system 100, by taking as an example a change in a business application. FIG. 21 is a flow chart illustrating a version-up (replacement) procedure for a business application to be executed by the system configuration employment control processing part 117. This procedure starts after a change in the field 911 of the environment definition screen 900 (FIG. 9) subjected to transition as the AP change button 1208 shown in FIG. 12 is clicked during the operation of the business system 100, to thereby execute replacement of a business application without halting the whole business system 100.

First, units are searched from the unit configuration definition table 1600 by using as a search key the name of the system to be activated (Step 2101). For each searched unit (if Yes at Step 2102, and for each of the “unit 1” and “unit 2” in the case shown in FIG. 16), Steps 2103, 2104, 2105 and 2106 are executed.

For each unit, the method blockRequest of the common interface 501 is executed (Step 2103) to block a request from an end user which the load balancer 107 distributes otherwise to the unit whose business application is to be changed. Next, the method stopApplications of the common interface 501 is executed (Step 2104) to stop execution of the business application for the services in the unit. Next, the method redeployApplications of the common interface 501 is executed (Step 2105) to replace the application for the services in the unit. Next, the method startApplications of the common interface 501 is executed (Step 2106) to start the business application. Lastly, the method acceptRequest of the common interface 501 is executed (S2107) to restart the request from the end user to be distributed to the unit by the load balancer 107.

In this manner, only a particular unit is halted and the business application is replaced at Steps 2103 to 2107 of the above-described procedure so that services by the business system 100 are not halted as a whole and the request from the end user can be processed at the remaining units.

Next, description will be made on a parameter definition updating procedure of non-stop 24 hours as another employment operation example. The system configuration employment control processing part 117 starts the parameter definition updating procedure after the tier common service environment definition table 1500 is updated by inputting a parameter change value in the field 903 shown in FIG. 9. This process flow is almost similar to that shown in FIG. 21. A redistribution process for environment definition is executed relative to the unit in a halt state by sequentially locking units out to partially regenerating the business system 100. Specifically, Steps 2104, 2105 and 2106 are replaced with Step of stopping services of the unit by executing the method stopServices, Step 1905 for the method setupServices, Step 1907, Step of setting again the environment definition and redistributing the setting file, and Step of executing the method startServices.

The process flow shown in FIG. 21 and the above-described parameter definition updating procedure of non-stop 24 hours indicate a typical process flow for a non-stop 24 hours operation. A particular unit is halted (executing one or a combination of blockRequest, stopServices and stopApplications), a maintenance operation suitable for an employment object is executed during the unit halt, and then the unit restart process (executing one or a combination of acceptRequest, startServices and startApplications) is executed. These operations are repeated for each of the units constituting the business system 100.

The maintenance operation illustrated by the process flow shown in FIG. 21 is to redeploy applications (redeployApplications), and to redistribute the setting file in the above-described parameter definition updating procedure of non-stop 24 hours. Other conceivable employment operations includes a process of patching OS, backup of the memory device and the like. For these employment operations under non-stop 24 hours, a program implementing the employment operation in the unit basis suitable for each object is prepared beforehand and called by a procedure similar to the process flow shown in FIG. 21.

The procedures shown in FIGS. 19 and 20 are the procedure of initially configuring the business system 100. These procedures may be applied to the case in which the configuration of a unit is changed (addition and deletion) after the business system 100 is configured. In this case, as illustrated in FIGS. 19 and 20, the procedure is executed only for specific units without executing it for all units constituting the business system 100. If the load of the business system 100 exceeds its rated process capability, a new unit is added so that it can deal with the capacity over the rated process capability. Conversely, if the load is greatly smaller than the rated process capability, a particular running unit is halted and thereafter deleted. Unit addition and deletion are performed on the screen 1000 shown in FIG. 10 subjected to transition by the unit configuration change button 1209 shown in FIG. 12.

6. Process Flow of Employment Logic Dependent Upon Configuration Pattern

With reference to the flow charts shown in FIGS. 22 to 26, description will be made on an implementation example of the common interface 501 for the configuration patterns to which the business system 100 shown in FIG. 3 belongs. These flow charts illustrate the process of each method in the configuration employment procedure (FIGS. 19 to 21) independent from the configuration of the business system 100. The process contents of each method may change with the configuration pattern of the system apparatus 106.

In summary, the method createServiceDefinitions (FIG. 5) creates the service instance definition information table 1800 from the configuration definition information entered in the screens shown in FIGS. 7 to 12, and the other methods transmit various configuration employment commands and the setting file to the load balancer 107 or system apparatus 106 by using the table 1800.

FIG. 22 is a flow chart illustrating the procedure of implementing the method createServiceDefinitions. The service instance definition information created by this procedure is stored in the service instance definition table 1800 shown in FIG. 18. The configuration definitions entered in the screens shown in FIGS. 7 to 12 define topologies of apparatuses, system apparatus information, and parameters for each service type to be set common at each tier, although the configuration definitions do not still define the instance of an individual service operating at each apparatus. This process flow creates the instance definition of an individual service by using the unit configuration definition table 1600, unit configuration pattern definition table 112 storing the service configuration, tier common service environment definition table 1500 and server machine definition table 1700.

First, the unit configuration definition table 1600 is searched by using as search keys the system name and the unit name which are arguments of the method (Step 2201). For each searched record (two records 1611 and 1612 for the “unit 1” at Step 2202), Steps 2203 to 2207 are executed.

At Step 2203 the value of the configuration pattern name field 1302 corresponding to the system name argument is acquired from the basic information table 1300. A list of service types hosted by the tier (values in the service type name field 606) is acquired from the configuration pattern definition table 113, by using as search keys the acquired pattern name (“HTTP separate 2-tier configuration for the “system 1”) and the tier name of the record being processed (the value in the tier name field 1604).

For each acquired service type (Step 2204), a service instance definition is executed (Steps 2205 to 2207). For example, in FIG. 6, the HTTP tier 611 has two service types, the HTTP service 621 and logging service 622, so that two service instance definitions for the HTTP service and logging service are executed for each server machine belonging to the HTTP tier. Similarly, the J2EE tier 612 of the business system 100 shown in FIG. 3 has four system apparatuses 311 to 314 each running two services, so that eight service instance definitions are executed (FIG. 18).

The service instance definition process includes Step 2205, Step 2206 and Step 2207. First, a new service instance definition record is created in the service instance definition table 1800. A name guaranteeing its uniqueness in the service instance definition table 1800 is automatically created and stored in the service name field 1801 of the new service instance definition record. A system name field 1802, a unit name field 1803, a server machine name field 1804 and a tier name field 1805 of the new service instance definition record are set with the system name and unit name designated by the arguments, the name of a server machine being processed (corresponding to the value in the server name field 1603) and the name of the tier (corresponding to the value in the tier name field 1604), respectively. The name of the service type being processed (corresponding to the value in the service type name field 606) is stored in a service type field 1808 (Step 2205).

Next, the service environment definition table 1500 is searched by using as search keys the system name designated by the argument, the service type name being processed and the tier name being processed (corresponding to the value in the tier name field 1604), to thereby acquire the environment definition 1504 and application information 1505 which are stored in an environment definition field 1806 and application information field 1807, respectively (Step 2206). At Step 2206, the parameter definition and application information defined common to tiers are developed (copied) to the individual service instance definition belonging to the same tier.

Lastly, parameters determined from information of the system apparatuses (server machine definition table 1700) and the topologies of the configuration patterns are added to the list of the environment definition field 1806 of the new service instance definition record (Step 2207). For example, in FIG. 3, J2EE service connected to the HTTP service 321 of the host 1 311 is the J2EE service of the host 2 312 in the same unit 304. Therefore, the value of the “address information of J2EE service to be connected”, which is a setting parameter for the HTTP service 321, can be known as the network address “192.1.1.2” from the server machine definition table 1700. A parameter solution procedure for each configuration can be realized by hard-coding the process of referring to various tables 113 and 14 to the plugin file 103 for each configuration.

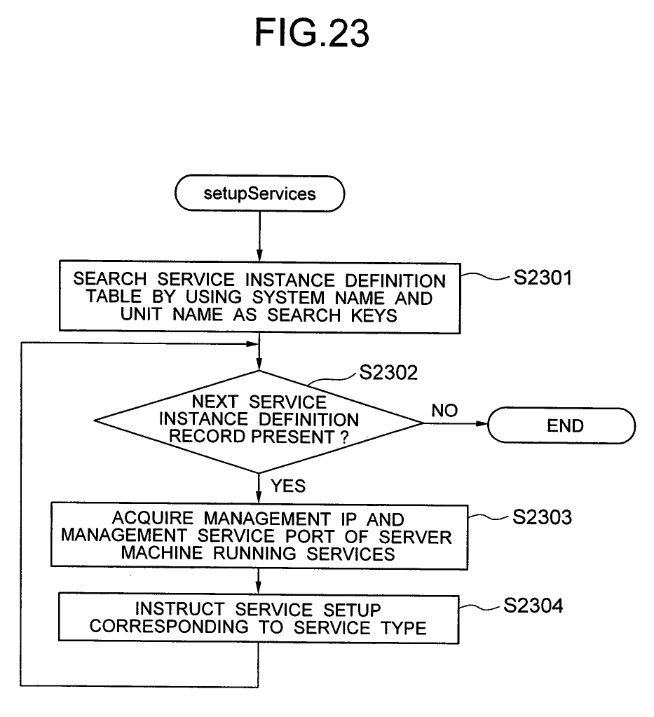

FIG. 23 is a flow chart illustrating a procedure of implementing the method setupServices. First, the service instance definition table 1800 is searched by using as search keys system name and unit name arguments (Step 2301). For each searched service instance definition (Step 2302), service setup is effected. The service setup includes the following Steps. First, the network information (management IP address 1703 and port number 1704) corresponding to the server machine name 1804 in the service instance definition is acquired from the service machine definition table 1700 (Step 2303). Next, by using the management IP address and port number, the management agent service 119 of the server machine is connected. A command string for the service setup corresponding to the service type is sent to the management agent service 119 which executed the command string (Step 2304).

The procedure for the method unsetupServices is almost similar to that shown in FIG. 23. In place of Step 2304, a command string is transmitted to the management agent service 119, the command string instructing to delete various files and settings regarding the services of the system apparatus 106, and a command string is also transmitted to the load balancer 107, the command string instructing to delete the definition of the virtual server executed at Step 1901 shown in FIG. 19 and the definition of the real server executed by the method joinVirtualServer.

The method distributeConfiguration is almost similar to that shown in FIG. 23. In place of Step 2304, a setting file corresponding to the service type is created from the environment definition 1806 in the list of name value pairs of various setting parameters, and distributed to the management agent service 119. An example of the created file is a file called httpd.conf for the service type of HTTP service.

The procedure for the method startServices is almost similar to that shown in FIG. 23. In place of Step 2304, a command string for the service activation process corresponding to the service type is transmitted to the management agent service 119.

The procedure for the method stopServices is almost similar to that shown in FIG. 23. In place of Step 2304, a command string for the service stop process corresponding to the service type is transmitted to the management agent service 119.

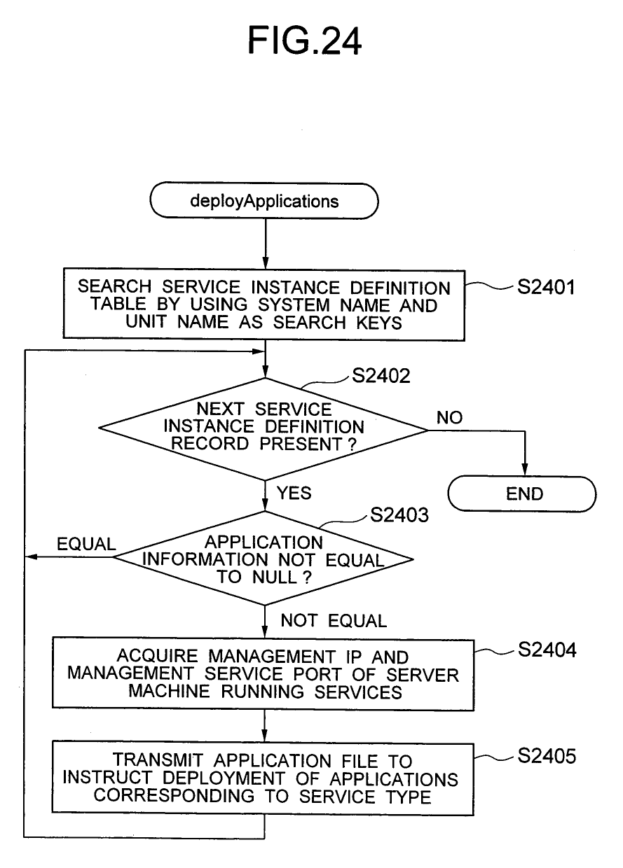

FIG. 24 is a flow chart illustrating the procedure of implementing the method deployApplications. First, the service instance definition table 1800 is searched by using as search keys the system name and unit name arguments (Step 2401). For each searched service instance definition (Step 2402), an application deploy process is executed if the application information field 1807 is not null (Step 2403). The application deploy process includes the following Steps. First, the network information (management IP address 1703 and port number 1704) corresponding to the server machine name 1804 in the service instance definition is acquired from the service machine definition table 1700 (Step 2304). Next, by using the information acquired at Step 2404, the management agent service 119 is connected. After the application file designated by the application field 1807 in the service instance definition table 1800 is transmitted, a command string for the application deploy process corresponding to the service type is transmitted (Step 2405).

The procedure for the method undeployApplications is almost similar to that shown in FIG. 24. In place of Step 2405, an application undeploy command is transmitted to the management agent service 119.

The procedure for the method startApplications is almost similar to that shown in FIG. 24. In place of Step 2405, an application start command is transmitted to the management agent service 119.

The procedure for the method stopApplications is almost similar to that shown in FIG. 24. In place of Step 2405, an application stop command is transmitted to the management agent service 119.

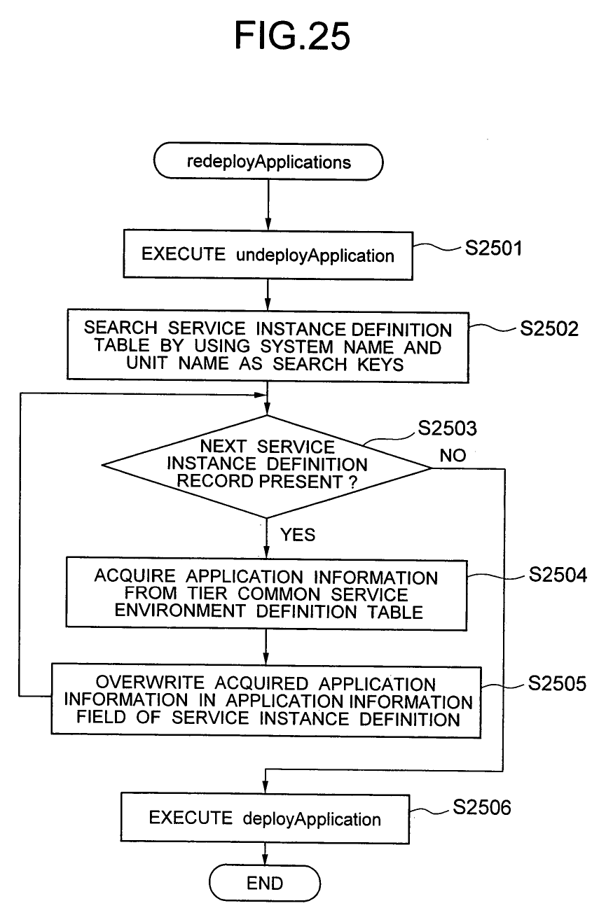

FIG. 25 is a flow chart illustrating the procedure of implementing the method redeployApplications. First, the method undeployApplications is executed to undeploy applications in the unit (Step 2501). Next, the service instance definition table 1800 is searched by using as search keys the system name and unit name arguments (Step 2502). For each searched service instance definition (Step 2503), the application information 1505 is acquired from the tier common service environment definition table 1500 by using as search keys the tier name 1804 and service type 1808 in the service instance definition (Step 2504). The acquired application information is overwritten in the application information field 1804 of the service instance definition table (Step 2505). Lastly, the method deployApplications is executed (Step 2506).

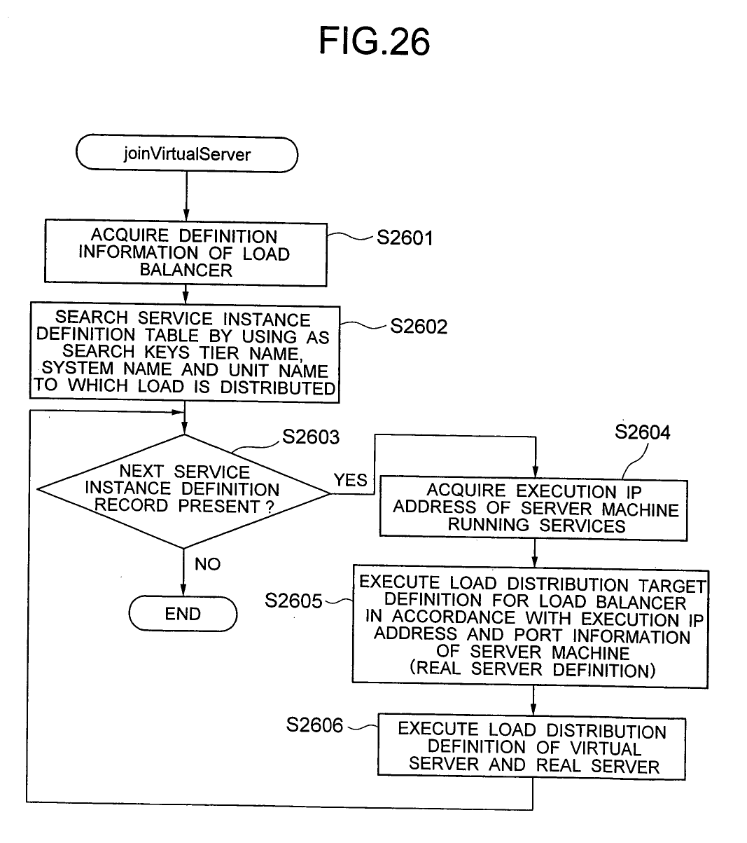

FIG. 26 is a flow chart illustrating the procedure of implementing the method joinVirtualServer. In the case of the business system 100 shown in FIG. 3, the load balancer 107 is instructed that the HTTP service in the unit is a load distribution target (a load distribution target is called a real server): (real server definition), to thereby execute the load distribution definitions of the virtual server and real server. For example, if the unit 304 shown in FIG. 3 is added to the virtual server, the real server definition is created for the HTTP service 321 and then load distribution definition is created so that the virtual server having “192.1.100” as VIP executes the load distribution of the real server.

The process flow shown in FIG. 26 is as follows. First, the employment management IP address 1403 and virtual server information (virtual IP address 1404 and port number 1405) of the load balancer are acquired from the load balancer definition table 1400 by using as a search key the system name argument (Step 2601). Next, the service instance definition table 1800 is searched by using as search keys the system name, the unit name, and the tier name as the load distribution target (in the configuration shown in FIG. 3, the HTTP tier is the load distribution target) (Step 2602). For each searched service instance definition (Step 2603), a participation process of making a service instance definition participate in the load distribution targets to the virtual server is executed. The participation process for the load distribution target includes the following Steps. First, the execution IP address 1702 of the server machine 1804 running the services is acquired from the server machine definition table 1700 (Step 2604). Namely, this execution IP address is an IP address of the real server. In this embodiment it is assumed that the port number of the real server uses the same port number as that of the virtual server.

Reverting to the process flow shown in FIG. 26, next, a command string for the load distribution target definition (real server definition) to be supplied to the load balancer 107 is created from the acquired port information 1405 and server machine execution IP address 1702 in the load balancer definition information, and transmitted to the load balancer 107 (Step 2605). A suitable example for the load balancer 107 has a means for defining a real server by using as arguments the load distribution IP address and port number. Lastly, a command string for instructing that the virtual server executes the load distribution of the real server is generated and transmitted to the load balancer 107 (Step 2606). In the above-described procedure, the employment management IP address 1403 in the load balancer definition information table 1400 is used for communications with the load balancer 107.

The procedure for the method leaveVirtualServer is almost similar to that shown in FIG. 26. In place of Steps 2605 and 2606, a command string for deleting the load distribution target definition to be supplied to the load balancer 107 is transmitted to the load balancer 107.

The procedure for the method acceptRequest is almost similar to that shown in FIG. 26. In place of Steps 2605 and 2606, a command string for enabling the load distribution to the real server is transmitted to the load balancer 107.

The procedure for the method blockRequest is almost similar to that shown in FIG. 26. In place of Steps 2605 and 2606, a command string for disabling the load distribution to the real server is transmitted to the load balancer 107.

As described above, according to the employment management system for the business system, since the unit as the management unit capable of partial lock-out and restart is defined for the business system 100, the whole business system 100 will not halt and the employment operation (such as application replacement) is possible at the system apparatus 106.

As the common interface 501 is used, general-purpose configuration and management at the system level are possible without depending upon the configuration pattern of the business system 100. Each configuration pattern can be dealt with by making a program for implementing the common interface 501 generated in accordance with the configuration patterns in the unit, have a correspondence with the definition information of he unit. It is therefore possible to localize the works of configuration and employment of the business system 100 and to reduce a load of developers and operators.

A program for executing the employment method of the above-described business system may be stored in a computer readable storage medium and read by a computer memory to be executed.

The above description of the embodiment does not limit the aspects of the present invention. For example, connection to an end user is not limited to the Internet, but other communication lines such as LAN (Local Area Network) and private lines may also be used. Specific configurations may be changed when necessary without departing from the main features of the present invention.

It should be further understood by those skilled in the art that although the foregoing description has been made on embodiments of the invention, the invention is not limited thereto and various changes and modifications may be made without departing from the spirit of the invention and the scope of the appended claims.

1. A business system employing method for a business system having a plurality of system apparatuses and being employed by an employment management system, wherein:
said employment management system comprises an arithmetic processing part and a storage device;
said storage device stores unit configuration information defining a unit of a predetermined number of said plurality of system apparatuses, a plurality of methods constituting an invariable common interface for configuration employment operations being independent from a configuration pattern of said unit, and a program to be executed for each method and determined depending upon the configuration pattern of said unit;
said common interface comprises as said method at least a partial halt method for making said unit halt an operation of said business system and a partial restart method for making said unit restart the operation of said business system; and
when said arithmetic processing part performs employment operations by making a predetermined system apparatus halt the operation of said business system, said arithmetic processing part executes said partial halt method to make said unit including the predetermined system apparatus and identified by referring to said unit configuration information, halt the operation of said business system, executes said employment operations, and after a completion of the employment operations, executes said partial restart method to restart the operations of said business system.

2. The business system employment method according to claim 1, wherein: said business system comprises a load balancer for distributing accesses from external communication apparatuses into said plurality of units;
said common interface further comprises as said method a distribution stop method for making said load balancer stop distribution of an access to a predetermined unit and a distribution restart method for making said load balancer restart the distribution of the access to the predetermined unit; and
when said arithmetic processing part performs employment operations by making a predetermined system apparatus halt the operation of said business system, prior to the halt of the operation said arithmetic processing part executes said partial stop method to make said load balancer stop distribution of an access to said unit including the predetermined system apparatus and identified by referring to said unit configuration information, and after a restart of the operation, executes said distribution restart method to make said load balancer restart the distribution of the access to said unit.

3. The business system employment method according to claim 1, wherein:
said common interface further comprises as said method a service definition method for generating service definition information necessary for a system apparatus as a portion of said business system in said unit to provide service, in accordance with said unit configuration information, a setup method for setting up service for each system apparatus in accordance with said service definition method, and a setting method for creating a configuration file of each system apparatus from said service definition information and distributing said configuration file; and
when said business system is configured, said arithmetic processing part generates said service definition information by executing said service definition method sequentially for each unit by referring to said unit configuration information, sets up each system apparatus by executing said setup method, and creating and distributing a configuration file of each system apparatus by executing said setting method.

4. The business system employment method according to claim 1, wherein:
said common interface further comprises as said method an application replacement method for replacing an application for each system apparatus in said unit; and
when an application is replaced as the employment operation of the predetermined system apparatus, said arithmetic processing part executes said application replacement method for said unit including the predetermined system apparatus and identified by referring to said unit configuration information, as an execution of said employment operation, to thereby replace the application of said predetermined system.

5. The business system employment method according to claim 3, wherein when a parameter as environment data is updated as the employment operation of the predetermined system, said arithmetic processing part executes said setup method for said unit including the predetermined system apparatus and identified by referring to said unit configuration information, as an execution of said employment operation, to thereby reflect a parameter changed in advance upon the predetermined system apparatus, and executes said setting method to create and distribute the configuration file of the predetermined system apparatus.

6. An employment management system for a business system having a plurality of system apparatuses, wherein:
said employment management system comprises an arithmetic processing part and a storage device;
said storage device stores unit configuration information defining a unit of a predetermined number of said plurality of system apparatuses, a plurality of methods constituting an invariable common interface for configuration employment operations being independent from a configuration pattern of said unit, and a program to be executed for each method and determined depending upon the configuration pattern of said unit;
said common interface comprises as said method at least a partial halt method for making said unit halt an operation of said business system and a partial restart method for making said unit restart the operation of said business system; and
when said arithmetic processing part performs employment operations by making a predetermined system apparatus halt the operation of said business system, said arithmetic processing part executes said partial halt method to make said unit including the predetermined system apparatus and identified by referring to said unit configuration information, halt the operation of said business system, executes said employment operations, and after a completion of the employment operations, executes said partial restart method to restart the operations of said business system.

7. The employment management system according to claim 6, wherein: said business system comprises a load balancer for distributing accesses from external communication apparatuses into said plurality of units;
said common interface further comprises as said method a distribution stop method for making said load balancer stop distribution of an access to a predetermined unit and a distribution restart method for making said load balancer restart the distribution of the access to the predetermined unit; and
when said arithmetic processing part performs employment operations by making a predetermined system apparatus halt the operation of said business system, prior to the halt of the operation said arithmetic processing part executes said partial stop method to make said load balancer stop distribution of an access to said unit including the predetermined system apparatus and identified by referring to said unit configuration information, and after a restart of the operation, executes said distribution restart method to make said load balancer restart the distribution of the access to said unit.

8. The employment management system according to claim 6, wherein:
said common interface further comprises as said method a service definition method for generating service definition information necessary for a system apparatus as a portion of said business system in said unit to provide service, in accordance with said unit configuration information, a setup method for setting up service for each system apparatus in accordance with said service definition method, and a setting method for creating a configuration file of each system apparatus from said service definition information and distributing said configuration file; and
when said business system is configured, said arithmetic processing part generates said service definition information by executing said service definition method sequentially for each unit by referring to said unit configuration information, sets up each system apparatus by executing said setup method, and creating and distributing a configuration file of each system apparatus by executing said setting method.

9. The employment management system according to claim 6, wherein:
said common interface further comprises as said method an application replacement method for replacing an application for each system apparatus in said unit; and
when an application is replaced as the employment operation of the predetermined system apparatus, said arithmetic processing part executes said application replacement method for said unit including the predetermined system apparatus and identified by referring to said unit configuration information, as an execution of said employment operation, to thereby replace the application of said predetermined system.

10. The business system employment method according to claim 8, wherein when a parameter as environment data is updated as the employment operation of the predetermined system, said arithmetic processing part executes said setup method for said unit including the predetermined system apparatus and identified by referring to said unit configuration information, as an execution of said employment operation, to thereby reflect a parameter changed in advance upon the predetermined system apparatus, and executes said setting method to create and distribute the configuration file of the predetermined system apparatus.

11. An employment program for making a computer execute the employment method for the business system according to claim 1.

12. A computer readable storage medium storing a program for making a computer execute the employment method for the business system according to claim 1.
